(19) United States
(12) Patent Application Publication
(10) Pub. No.: US 2012/0118770 A1
(43) Pub. Date: May 17, 2012

(54) TABLET ACCESSORY

(76) Inventors: William H. Valls, Loveland, OH (US); Zachariah Simmering, Mansfield, OH (US)

(21) Appl. No.: 13/108,568

(22) Filed: May 16, 2011

Related U.S. Application Data
(60) Provisional application No. 61/413,730, filed on Nov. 15, 2010.

(51) Int. Cl. B65D 85/00; F16M 11/20; F16M 13/00

(52) U.S. Cl. 206/320; 248/682; 248/688

(57) ABSTRACT

A tablet accessory is disclosed which permits a user to securely hold, rotate, transfer or otherwise manipulate a tablet using a single hand. The tablet accessory includes a knob, a base and a connector. The base is configured to be coupled to the knob. The connector is integrated into the base. The connector is configured to couple the tablet accessory to a tablet or case containing the tablet.

### CROSS-REFERENCE TO RELATED APPLICATIONS

This application claims priority to U.S. provisional patent application Ser. No. 61/413,730 filed on Nov. 15, 2010, the entirety of which is herein incorporated herein by reference.

### BACKGROUND

1. Technical Field

The present invention relates to an accessory for a tablet device, and more particularly, to an apparatus which permits a user to securely hold and rotate a tablet device with one hand.

2. Description of the Related Art

The sales and popularity of tablet devices is steadily increasing. Tablets such as the Apple iPad™, Motorola Xoom™, Research in Motion Playbook™ and Hewlett Packard TouchPad™ permit users to browse the web, listen to music, read emails and perform other similarly related computing functions. Other tablets such as the Barnes & Nobel Nook™ and the Amazon Kindle™ serve as eBook readers.

When users are operating a tablet device, the user often holds the tablet device with one hand and operates the device with the other hand. However, tablet devices are not ergonomically designed to be held with one hand. It is difficult for a user to hold the device in a manner which is both secure and comfortable, and which does not put strain on the user's hand or wrist.

When the tablet device is held with only one hand, the user risks dropping and damaging the device. This risk is due, at least in part, to the fact that many tablet devices are larger that the user's hand, thus preventing the user from securely holding or gripping the device. In addition, the backside of the tablet devices are not outfitted with a means to assist a user in holding the tablet device when the device is resting in the user's palm, or if they are outfitted with such a retaining means, the retaining means does not provide a user with adequate security when holding the device.

The risk of dropping or otherwise damaging a tablet device is amplified when the user attempts to rotate the device to view the screen at a particular angle, or when the user moves the device so that another viewer can see what is being displayed on the screen. In these types of scenarios, the device can easily slip out of a user's hand resulting in damage or destruction of the device.

### SUMMARY

In accordance with the present principles, a tablet accessory is disclosed. The tablet accessory includes a base which has two opposing ends. A knob is attached to a first end of the base and a connecting means is integrated into a second end of the base. The connecting means is configured to connect the base to an exterior surface of a tablet.

In accordance with the present principles, another tablet accessory is disclosed. The tablet accessory includes base having two opposing ends. A knob is located adjacent to a first end of the base and a connecting means is integrated into a second end of the base. The connecting means is configured to connect the base to a tablet case.

In accordance with present principles, another tablet accessory is disclosed. The tablet accessory includes a case having an inner surface and an outer surface. The inner surface is configured to receive a back side of a tablet. The outer surface has at least one receiver. A knob includes a shaft with an integrated connector for coupling the knob to the receiver.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1A is a side perspective of a tablet accessory attached to a tablet in accordance with an embodiment of the present principles.

FIG. 1B-1 is a side perspective demonstrating how a user can grip a tablet accessory attached to a tablet in accordance with an embodiment of the present principles.

FIG. 1B-2 is a side perspective demonstrating how a user can grip a tablet accessory attached to a tablet in accordance with another embodiment of the present principles.

FIG. 1B-3 is a top perspective providing a close-up view of a user's hand gripping a tablet accessory in accordance with an embodiment of the present principles.

FIG. 1C is a cross-sectional view of a tablet accessory in accordance with an embodiment of the present principles.

FIG. 1D is an exploded view of a tablet accessory in accordance with an embodiment of the present principles.

FIG. 1E is a side perspective of a tablet accessory with an attached stand that holds a tablet in a reclining position in accordance with an embodiment of the present principles.

FIG. 1F is a side perspective of the tablet accessory with the attached stand in FIG. 1E when the stand is holding the tablet in a standing position.

FIG. 1G is a side perspective of a tablet accessory including a connecting portion configured to be received by a receiving portion of tablet in accordance with an embodiment of the present principles.

FIG. 1H is a top perspective of a tablet including a receiving means configured to engage a connecting portion of tablet accessory in accordance with an embodiment of the present principles.

FIG. 1I is a block/flow diagram illustrating a method for operating a tablet accessory in accordance with an embodiment of the present principles.

FIG. 2A is a side perspective of a tablet accessory that includes a pivoting knob portion in accordance with an embodiment of the present principles.

FIG. 2B is a side perspective of the tablet accessory in FIG. 2A indicating a range of motion associated with the pivoting knob.

FIG. 2C is a cross-sectional view of the tablet accessory in FIG. 2A.

FIG. 3A is a side view of a handle stick tablet accessory attached to a tablet in accordance with an embodiment of the present principles.

FIG. 3B is a side view of the handle stick tablet accessory disclosed in FIG. 3A which illustrates how the handle stick can be used to prop up and support a tablet.

FIG. 3C is a top view of the handle stick tablet accessory disclosed in FIG. 3A.

FIG. 3D is a side view of the handle stick tablet accessory disclosed in FIG. 3A which illustrates how a user can hold a tablet with one hand.

FIG. 4A is a top view of a spinning tablet accessory in accordance with an embodiment of the present principles.

FIG. 4B is a side view of the spinning tablet accessory disclosed in FIG. 4A.

FIG. 4C is a cross-sectional view of the spinning tablet accessory disclosed in FIG. 4A.

FIG. 5A is a top view of a T-handle tablet accessory attached to a tablet in accordance with an embodiment of the present principles.

FIG. 5B is a side view of the T-handle tablet accessory disclosed in FIG. 5A.

FIG. 5C is a top view of the T-handle tablet accessory disclosed in FIG. 5A which illustrates how a user can hold a tablet in one hand.

FIG. 5D is a side view of the T-handle tablet accessory disclosed in FIG. 5A which illustrates how the T-handle tablet accessory can be used to prop up and support a tablet.

FIG. 6A is a top view of an umbrella tablet accessory in accordance with an embodiment of the present principles.

FIG. 6B is a side view of an umbrella tablet accessory disclosed in FIG. 6A.

FIG. 6C is a side view of the umbrella tablet accessory disclosed in FIG. 6A with a knob portion being in an up-position.

FIG. 6D is a side view of the umbrella tablet accessory disclosed in FIG. 6A illustrating a range of motion associated with a knob and release.

FIG. 7A is a tablet accessory including a tablet case in accordance with an embodiment of the present principles.

FIG. 7B is an inside surface of the tablet case in FIG. 7A in accordance with an embodiment of the present principles.

FIG. 7C is an outside surface of the tablet case in FIG. 7A in accordance with an embodiment of the present principles.

FIG. 7D is a side view of the tablet case in FIG. 7A in accordance with an embodiment of the present principles.

FIG. 7E is another embodiment a tablet case which includes an attached base portion.

FIG. 7F is a side view of the tablet case in FIG. 7E with an attached base portion in accordance with an embodiment of the present principles.

FIG. 8A is a top view of a dome-like tablet accessory attached to a tablet in accordance with an embodiment of the present principles.

FIG. 8B is a side view of the dome-like tablet accessory disclosed in FIG. 3A.

FIG. 8C is a side view of the dome-like tablet accessory disclosed in FIG. 3A which illustrates how the dome portion of the tablet accessory can be used to prop up and support a tablet.

FIG. 8D is a top view of the dome-like tablet accessory disclosed in FIG. 3A illustrating how a user hold can a tablet with one hand.

### DETAILED DESCRIPTION OF PREFERRED EMBODIMENTS

In accordance with the present principles, a tablet accessory is disclosed which permits a user to securely hold, rotate, transfer or otherwise manipulate a tablet. The tablet accessory may be attached to the backside of the tablet or a case containing the tablet. The user can securely and comfortably hold the tablet with a single hand by positioning the screen of the tablet such that it faces the user, and positioning his or her hand about the tablet accessory attached to the backside of the device. The tablet accessory permits the user to safely move or rotate the tablet at any angle, including upside down, while retaining a secure hold on the same using only one hand.

In one embodiment, the tablet accessory comprises a knob which is releasably attached to a base portion. The base portion may house a suction cup which fastens to the back of a tablet or mobile computing device. Those skilled in the art will appreciate that different mechanisms can be employed to create a vacuum seal between the suction cup and the tablet to provide a strong, non-permanent attachment between the tablet accessory and the tablet.

In one embodiment, the base portion or suction cup portion includes a threaded bolt which protrudes into the knob. As the knob is screwed onto the threaded bolt, the threaded bolt rises up into the knob and pulls on the top of the suction cup to create a vacuum seal between the tablet and the table accessory. As the knob is twisted to its final secure position, a connection is created between the tablet and tablet accessory that is sufficiently strong to hold the accessory onto the tablet.

In other embodiments, the suction cup on the tablet accessory is replaced with a connecting portion. The connecting portion is configured to engage and couple to a corresponding receiving portion located on the tablet or on a case that contains the tablet. The particular type of connection which is provided by the coupling of the connecting portion and receiving portion may vary. For example, the connection may include a magnetic connection, a “stick-and-click” connection, a threaded or screw-like connection, adhesive connection, Velcro™ connection, etc., or a combination of these connections.

The knob and the base may be detachable from each other or they may be fixedly connected to each other depending upon the particular embodiment. In the case where the knob is detachable, any suitable connection may be used to attach the knob to the base including, but not limited to, any of the connection means described herein for connecting a tablet accessory to a tablet.

The tablet accessory may include a stand which can be used to support the tablet. The stand can support the tablet in a reclining position or standing position. In certain embodiments, the stand is adjustable in a manner which permits a user to precisely set the position of the tablet. The stand may include a locking mechanism which securely locks the stand in a specific position. In certain embodiments, the tablet accessory itself is designed to serve as a stand, while in other embodiments the stand is a separate component which can be attached to the tablet accessory.

In some embodiments, a protective tablet casing may also be attached to a tablet to protect or secure the tablet, and to permit the attachment of a tablet accessory. The tablet case can be varied in a number of different ways. For example, cases may be designed, altered or adapted for different types of tablets (e.g., a case specifically tailored to the Apple iPad™ or the Research in Motion Playbook™). In addition, the means for attaching, joining or otherwise incorporating a tablet accessory into a tablet can be varied. In one embodiment, the tablet case may include a receiving portion that enables a tablet accessory to be coupled to the tablet case (e.g., by mating the receiving portion on the case with a corresponding connecting portion on a tablet accessory). In another embodiment, the tablet case may include an integrated base portion which can be coupled to a removable knob. Other types of connections may be employed for providing a tablet case with a tablet accessory.

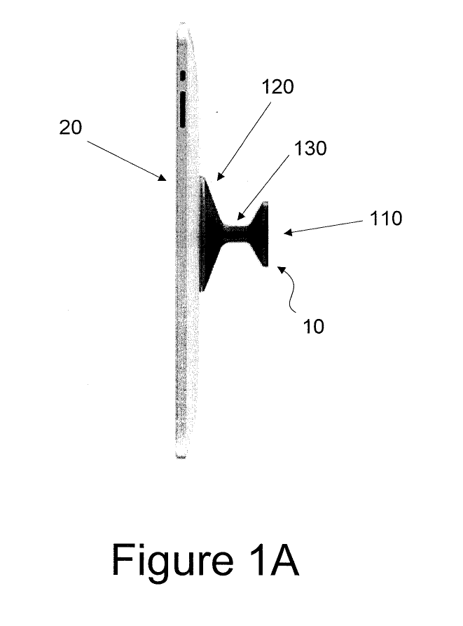

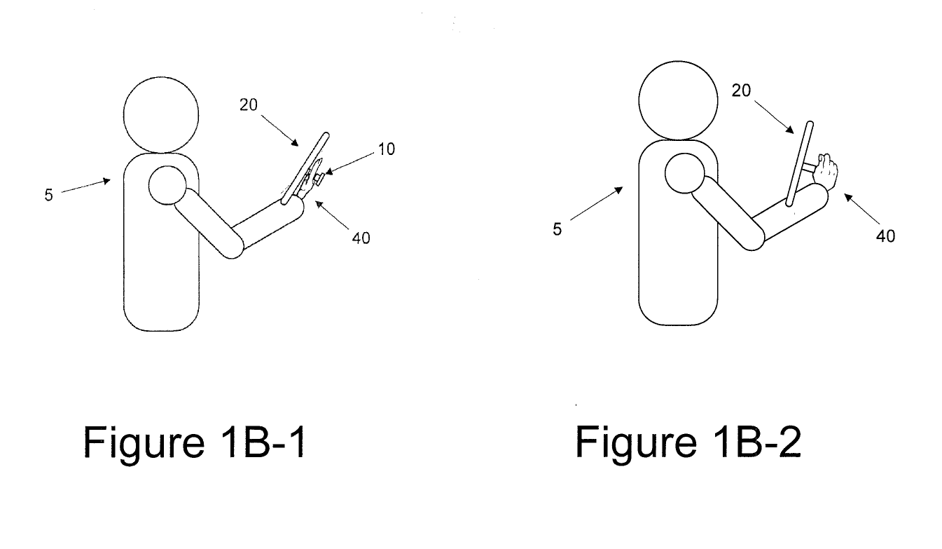

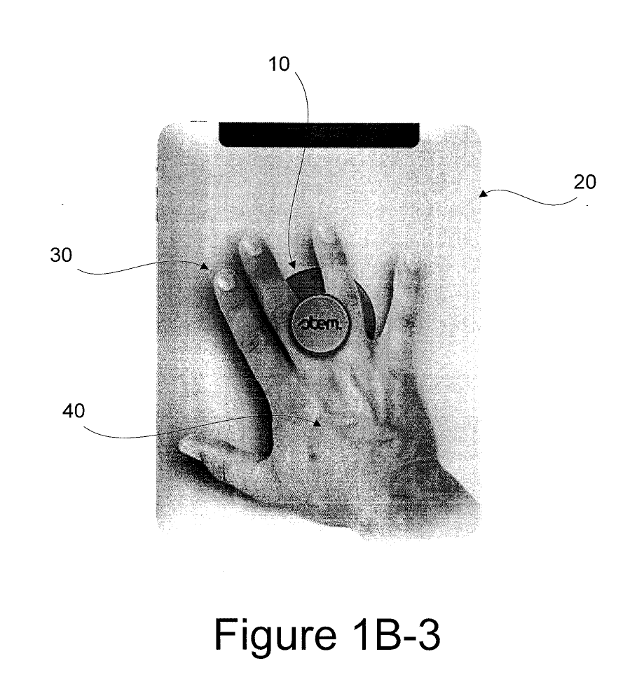

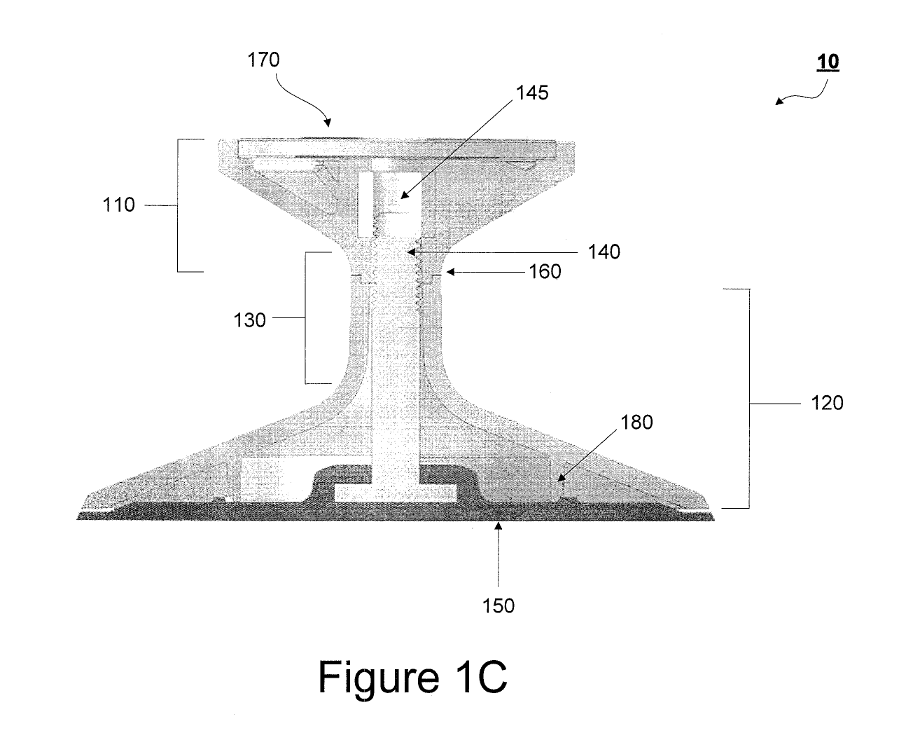

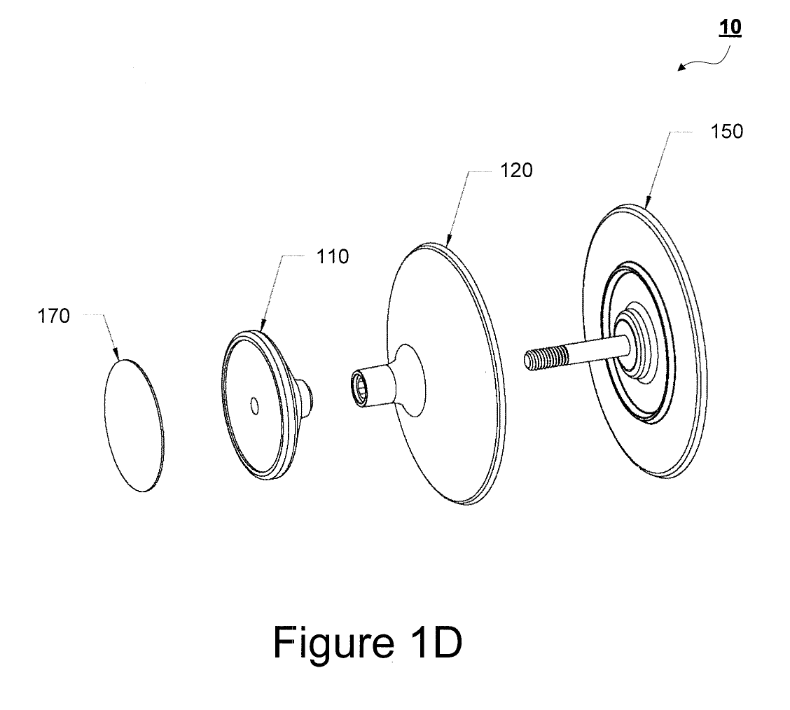

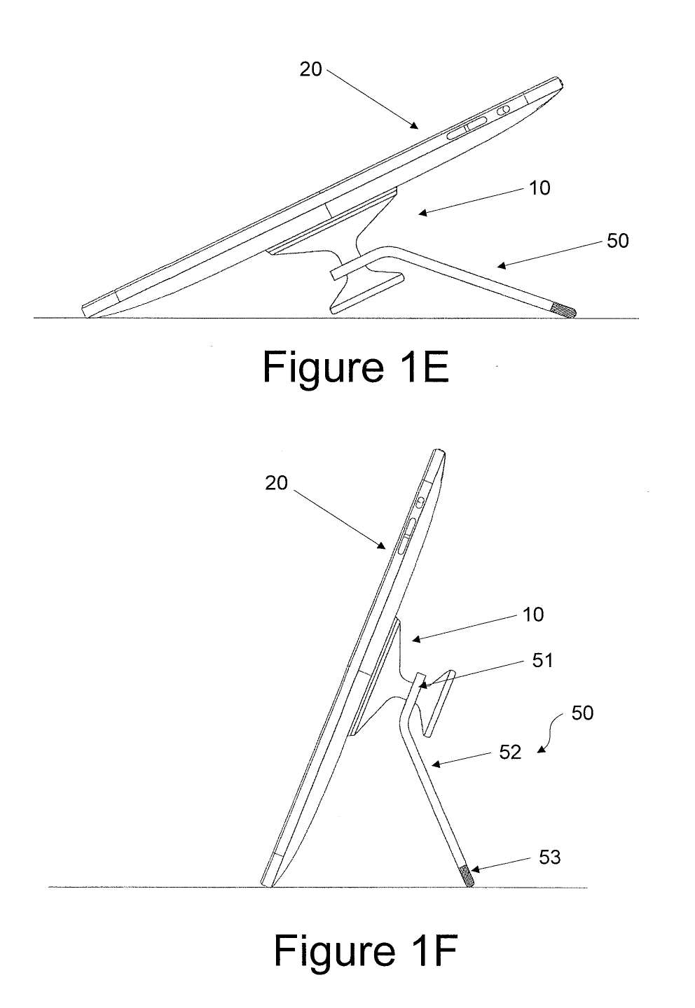

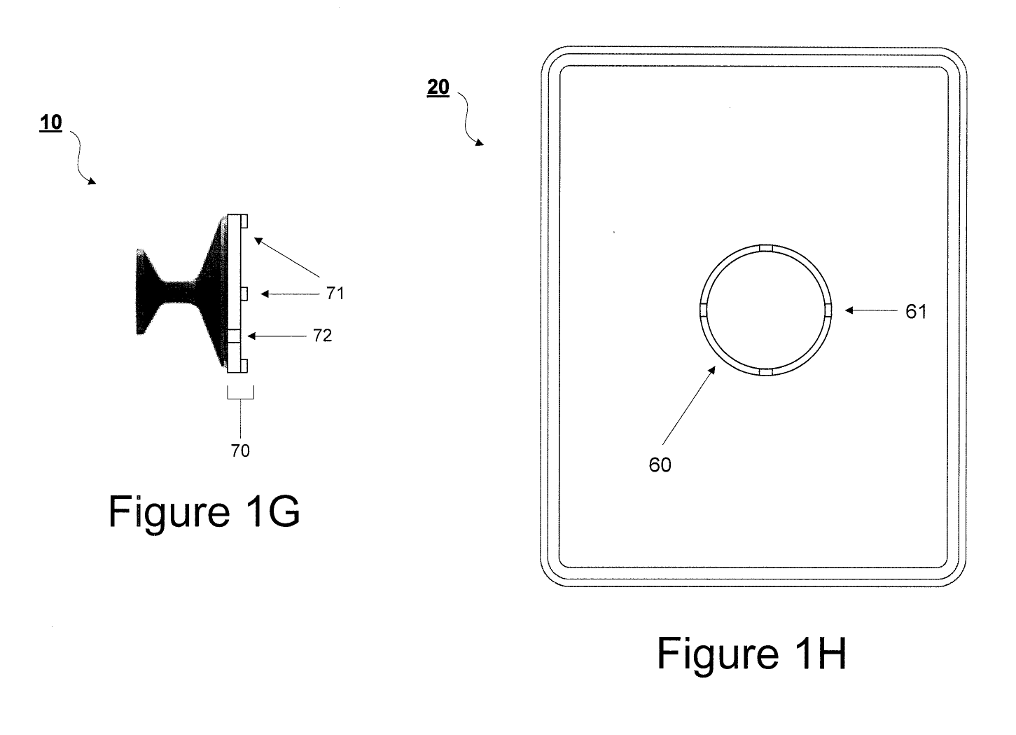

Several different embodiments of exemplary tablet accessories are disclosed. While certain embodiments may be described as including particular features, all features described herein may be applied to any disclosed embodiment. For example, certain embodiments of the tablet accessory may be described as including a connecting portion which is configured to be coupled to a corresponding receiving portion of a tablet (e.g., as depicted in FIGS. 1G and 1H), while other embodiments may be described as utilizing a suction cup for coupling the tablet accessory to a tablet. However, it would be apparent to one of ordinary skill in the art that all of the embodiments described herein can be modified appropriately to include any suitable type of connection. Likewise, although only certain embodiments may be described as including particular features (e.g., a stand, casing, release, gripping means, rotating knob or pivoting knob, etc.), it should be understood that all embodiments can be suitably adapted or modified to include these features.

This disclosure provides examples of how tablet accessories can be used in conjunction with a tablet. However, it should be recognized that the tablet accessories described herein can be used to hold, grip, rotate or manipulate other types of mobile computing devices and objects as well. Thus, the application of the tablet accessory is not limited in this sense.

Referring now to the drawings in which like numerals represent the same or similar elements and initially to FIG. 1A, a side perspective of a tablet accessory 10 attached to a tablet 20 is disclosed in accordance with an embodiment of the present principles. The tablet accessory 10 provides for a secure and comfortable means for retaining or holding the tablet 20 while the tablet 20 is being operated or while the tablet 20 is being transported in a user's hand 40. The design of the tablet accessory 10 permits a user to manipulate the device with one hand 40. The tablet accessory 10 can be manufactured using a variety of different materials including, but not limited to, plastics or metals.

The tablet 20 may represent an Apple iPad™, Motorola Xoom™, Hewlett Packard TouchPad™, Barnes & Nobel Nook™, Amazon Kindle™, Research in Motion Playbook™ or similar device. The tablet accessory 10 attached to the tablet 20 comprises a knob 110 and a base 120 which are coupled to each other to form a central shaft 130. The underside of the knob 110 can be designed with an upward angle and the top side of the base 120 can be designed with a downward angle. This angled configuration creates a spacing between the knob 110 and base 120 inclusive of central shaft 130 which permits a user to hold the tablet 20 in an advantageous manner.

FIGS. 1B-1, 1B-2 and 1B-3 demonstrate advantageous ways for holding a tablet 20. As shown therein, a tablet accessory 10 is attached to the back of a tablet 20 and the tablet accessory 10 is held by a user's hand 40 with the screen or display facing the user 5.

In accordance with FIG. 1B-1, the user 5 holds the tablet accessory 10 with the palm of his or her hand 40 facing the user 5. The user's fingers 30 are placed around the shaft 130 of the tablet accessory 10 while the user's hand 40 and fingers 30 are in contact with the backside of the tablet 20 to support the tablet 20. The knob 110 on the tablet accessory 10 protrudes through the user's fingers 30.

A close-up of the particular grip disclosed in FIG. 1B-1 is illustrated in FIG. 1-B3 which demonstrates how a user can position his or her hand 40 to securely hold and rotate the tablet 20. A user's hand 40 can be positioned in the spacing between the knob 110 and base 120 so that: (i) central shaft 130 is situated between two of the user's fingers 30; (ii) the user's palm is in contact with the top of the base 120 and the back of the tablet 20; (iii) the user's fingertips can be in contact with the back of the tablet 20; and (iv) the area on the back of the user's fingers 30 which are adjacent to the shaft 130, between the joints and knuckles, is in contact with the bottom of the knob 110.

Once the user's hand 40 and fingers 30 are correctly positioned, the combination of the attached accessory 10 and the points of contact between the user's hand 40, fingers 30, accessory 10 and tablet 20 establish a secure hold and retention of the tablet 20. The user can then securely and comfortably hold the tablet 20, and maneuver the tablet 20 with a single hand 40 in various positions and at any angle.

When using the tablet accessory 10 to hold the tablet 20 in accordance with the invention, the user can easily rotate the tablet 360 degrees in his/her hand 40, regardless of the position or angle that the tablet 20 is being held. This may be accomplished by simultaneously reducing the pressure between his/her fingers 30 around the shaft 130, reducing the pressure between the user's finger tips and the back of the tablet 20, and rotating the outer edge of the tablet 20 with the opposite other hand.

A second advantageous means of holding a tablet accessory 10 is illustratively depicted in FIG. 1-B2. Here, the palm of a user's hand 40 grasps the knob 110 of the tablet accessory 10 to securely hold the tablet 20. In certain embodiments, the bottom portion of the knob 110 closest to the shaft 130 can be designed with a lip, raised rib, groove, rubber ring or other means which would permit a user's 5 fingers to securely grasp the tablet accessory 110 when the tablet 20 is being held in this manner. This design also permits a user 5 to rotate the tablet 360 degrees in his/her hand 40 with a protective hold.

FIG. 1C shows a cross-sectional view of a tablet accessory 10 in accordance with an embodiment of the present principles. The tablet accessory 10 includes a knob 110 and a base 120 which converge to form central shaft 130. A step or notch arrangement 160 is incorporated into the knob 110 and the base 120 at the point where the knob 110 and base 120 meet. The step 160 ensures a secure alignment between the knob 110, the threaded bolt 140 and the base 120.

The top of the knob 110 is designed to receive an insert 170 (e.g., a logo, advertisement, label, etc.) which can be attached to the knob 110 in any manner (e.g., using an adhesive). The knob 110 also includes a threaded recess 145 for receiving the threaded bolt 140. The threaded bolt 140 is attached to the suction cup 150 and received through a hole in the base 120. The knob 110 is screwed onto the threaded bolt 140 that is protruding from the base 120. As the knob 110 is rotated, the threaded bolt 140 rises up into the threaded recess 145 portion of the knob 110 and pulls on the top of the suction cup 150. This will create a vacuum seal between the tablet 20 and the suction cup 150. As the knob 110 is twisted, the vacuum sealed connection between the suction cup 150 and tablet 20 increases in strength to a predetermined point defined by the mating of the knob 110 and the base 120.

An inside wall 180 exists within the base 120 that connects the interior wall of the base 120 and the suction cup 150. The inside wall 180 holds the suction cup 150 in the desired position within the base 120 and keeps the edges of the suction cup 150 attached to the back of the tablet 20 when the knob 110 is being screwed onto the threaded bolt 140 and the threaded bolt 140 is pulling on the top of the suction cup 150. As explained above, this action creates a vacuum seal between the suction cup 150 and the back of the tablet 20, and provides for a secure attachment between the tablet accessory 10 and the tablet 20.

To remove the tablet accessory 10 from the back of the tablet 20, the user 5 unscrews the knob 110 from the threaded bolt 140. This causes the threaded bolt 140 to descend and lower the top of the suction cup 150, thus relieving the suction pressure and vacuum seal between the tablet accessory 10 and the tablet 20. In this manner, the user can remove the tablet accessory 10 from the tablet 20 with little effort.

FIG. 1D provides an exploded view of the tablet accessory 10 shown in FIG. 1C. In this embodiment, the tablet accessory 10 can be made up of three parts: knob 110, base 120 and suction cup 150. The suction cup 150 is attached to the threaded bolt 140. The base 120 houses the suction cup 150 and receives the threaded bolt 140 via a hole which is located in the center of the base 120. The knob 110 can be screwed onto the threaded bolt 140 protruding through the base 120. An insert or label 170 can be attached or integrated into the top part of the knob 110. The insert 170 may be represent an actual label or logo which is being attached to the knob 110, or a element (e.g., a transparent piece of plastic) which assists in attaching a label or logo to the knob 110.

FIGS. 1E-1F disclose a stand 50 which can be used in conjunction with the tablet accessory 110 to prop up and support a tablet 20. FIG. 1E illustrates how the stand 50 can support a tablet 20 in a reclining position, while FIG. 1F illustrates how the stand 50 can support a tablet 20 in a standing position.

The stand 50 can include two portions. A first portion 51 is connected to the shaft 130 of the tablet accessory 110 and a second portion 52. The first portion 51 may be connected to the shaft 130 in a number of different ways. For example, the first portion 51 may include a U-shaped recess for receiving the shaft 130, or may be configured to click or snap onto the shaft 130. As an alternative, the stand 50 may include a hole which can receive the bolt 140 protruding from the base 120. In this case, the stand 50 could be slid onto the bolt 140 before the knob 110 is screwed on behind it. In other embodiments, the stand 50 can be attached to the tablet accessory 10 by unscrewing the knob 110 and replacing the knob 110 with a stand 50. In this case, the stand 50 could include a threaded recess that could be screwed onto the threaded bolt 140.

The second portion 52 is longer in length then the first portion 110. The second portion 52 supports the tablet 20 and can hold the tablet 20 in a reclining position (e.g., as in FIG. 1E) or standing position (e.g., as in FIG. 1F). A friction means 53 may be located at the bottom of the second portion 52 where the second portion 52 comes into contact with the ground or surface. The friction means 53 is configured to have a sufficiently high coefficient of friction to prevent the second portion 52 of the stand 50 from sliding on the surface. To provide a high coefficient of friction, the friction means 53 may include materials (e.g., rubber, fabrics, etc.) or textures (e.g., raised bumps, grooved surfaces, etc.) which are designed to prevent the second portion 52 from sliding on a surface.

In certain embodiments, the stand 50 the stand depicted in FIGS. 1E and 1F may be adjustable so that the position of the tablet 20 can be precisely tailored or set by a user. This can be accomplished by incorporating an adjusting means (not shown) into the stand 50. In one example, the adjusting means may comprise a rotatable hinge located at the point where the first portion 51 comes together with the second portion 52 of the stand 50. The hinge allows a user to set the angle at which the first portion 51 converges with the second portion 52, thus permitting the user to position the tablet 20 at any viewing angle. The hinge (or other adjusting means) may include a locking mechanism which would allow the user to lock the hinge at a particular angle so that the position of the tablet 20 can be precisely set by the user 5.

FIGS. 1G-1H disclose a modified version of a tablet accessory 10 and tablet 20. In contrast to the embodiments described in FIGS. 1C and 1D, the tablet accessory 10 does not include a suction cup 150 for coupling the tablet accessory 10 to the tablet 20. The modified tablet accessory 10 replaces the suction cup 150 with a connecting portion 70. The connecting portion 70 is configured to be coupled to a corresponding receiving portion 60 located on the tablet 20.

Those of ordinary skill in the art will recognize that the particular type of connection provided by coupling the connecting portion 70 on the tablet accessory 10 with the receiving portion 60 on the tablet 20 can be varied without departing from the scope of the invention. For example, the connecting portion 60 may comprise a threaded portion (e.g., a male threaded portion or female threaded portion) which can be screwed into or received by the receiving portion 60. As another alternative, a magnetic connection may be employed to connect the connecting portion 70 and receiving portion 60, where the connecting portion 70 and receiving portion 60 each include magnets with opposite polarity.

Other examples of connecting the tablet 20 and the tablet accessory 10 may utilize Velcro™ or an adhesive (e.g., adhesive tape strips). For example, the receiving portion 60 and connecting portion 70 may comprise strips of Velcro™ or adhesive strips which can be used to coupled the tablet 20 to the tablet accessory 10. In even further embodiments, only one of the connecting portion 70 or receiving portion 60 is needed to couple the tablet accessory 10 to the tablet 20. For example, a single adhesive strip (which may represent either the connecting portion 70 or the receiving 60) may be used to couple the tablet accessory 10 to the tablet 20. In addition to those described above, numerous other types of connection mechanisms are contemplated, and are intended to be encompassed by the present principles.

In the exemplary embodiment disclosed in FIGS. 1G and 1H, a “stick-and-click” connection is provided for coupling the connecting portion 70 and receiving portion 60. Specifically, the connecting portion 70 includes a plurality of flanges or teeth 71 that can be received by recesses 61 located on the receiving portion 60. In order to connect the tablet accessory 10 to the tablet 20, a user 5 simply places the connecting portion 70 on top of the receiving portion 60 when the teeth 71 are aligned with the recesses 61. Once aligned, pressure can be applied so that the portions 60 and 70 “click” or “snap” together. The recesses 61 may include friction tabs (not shown) that serve to couple the portions 60 and 70 together when enough pressure is applied.

A securing mechanism (not shown) may also be provided to ensure that the tablet accessory 10 is securely coupled to the tablet 20. For example, in the case that the above-described stick-and-click connection scheme is employed, the connecting portion 70 and receiving portion 60 may be configured such that the knob 110 of the tablet accessory 10 can be rotated or turned to lock the portions 60 and 70 in place. Thus, a user 5 would apply pressure to couple the portions 60 and 70 together, and then rotate the knob 110 to lock the portions 60 and 70 together (e.g., by rotating the position of the teeth 71 slightly such that the teeth 71 cannot be disengaged from the recesses 61 or by causing a separate flange to engage another recess of the receiving portion 60).

The connecting portion 70 may also include a release 72 which disengages the teeth 71 from the recesses 61 in the receiving portion 60 and permits the tablet accessory 10 to be easily removed from the tablet 20. In other embodiments, the release 52 may be located on the receiving portion 60 of the tablet 20.

Although the present disclosure may describe an embodiment of a tablet accessory 10 as including a particular type of connecting means (e.g., suction cup 150), it should be understood that all of the tablet accessories 10 disclosed in this application can be modified to include a connecting portion 70 which engages a corresponding receiving portion 60 located on the tablet 20 as shown in FIGS. 1G and 1H.

FIG. 1I discloses an exemplary method 190 for operating the tablet accessories 10 disclosed in FIGS. 1A-1H. The method begins at the start block and proceeds to step 191 where a coupling is created between a tablet accessory 10 and a tablet 20. Specifically, a connecting means located on the bottom side of a tablet accessory 10 is attached to a surface of a tablet 20.

If the connecting means on the tablet accessory 10 comprises a suction cup design (e.g., as illustrated in FIG. 1C), this may involve placing the suction cup 150 on the surface of the tablet 20. Alternatively, if the connecting means comprises a connecting portion 70 (e.g., as illustrated with by FIGS. 1G and 1H), this may involve coupling a connecting portion 70 of the tablet accessory 10 to a receiving portion 60 of the tablet 20. For example, if the corresponding connecting and receiving portions 70 and 60 are configured to provide a stick-and-click connection, a coupling could be created by applying pressure until the portions 70 and 60 snap or click into place.

Step 192 is optional step which may be relevant to particular embodiments of the invention. In step 192, a knob 110 located on the top side of the tablet accessory 10 is rotated to strengthen the connection between the tablet 20 and the connecting means located on the tablet accessory 10. For example, the rotation of the knob 110 may cause a bolt in the base 120 to rise into the knob 110. The rising of the bolt into the knob 110 can trigger a mechanism for strengthening the coupling between the tablet accessory 10 and the tablet 20.

In the case that the connecting means comprises a suction cup 150, the bolt may be attached to a top portion of the suction cup 150. As the bolt rises into the knob 110, the bolt pulls on the top of the suction cup 150 to create a vacuum seal between the suction cup 150 and the tablet 20. The connection between the tablet 20 and the tablet accessory 10 can be strengthened in this manner.

The rotation of the knob 110 may also serve to strengthen a coupling between the connecting means and the tablet 20 in the case where the connecting means is outfitted with a connecting portion 70 which is configured to engage a receiving portion 60 on the tablet 20. For example, if a magnetic connection were employed by portions 60 and 70, the rotation of the knob 110 may serve to cause the bolt to descend in the direction of the tablet 20, rather than being pulled up into the knob 110. The descending bolt could then strengthen the coupling by pushing down on a magnet situated in the connecting portion 70 until the magnet ultimately converges with a corresponding magnet in the receiving portion 60.

In step 193, the connection between the connecting means and the tablet 20 is broken, and the tablet accessory 10 is decoupled from the tablet 20. This may be accomplished using a disengaging means. The disengaging means may include rotating the knob 110 in the opposite direction to weaken the connection between the tablet 20 and tablet accessory 10. Alternatively, the disengaging means may comprise a separate release (e.g., release 72 in FIG. 1G). The separate release may represent a button, switch, etc. which can be pressed to break a vacuum seal of a suction cup 150, to disengage teeth 71 in a stick-and-click connection, or provide some other means of decoupling the tablet accessory 10 and tablet 20. The release can be adapted to the particular type of connection employed.

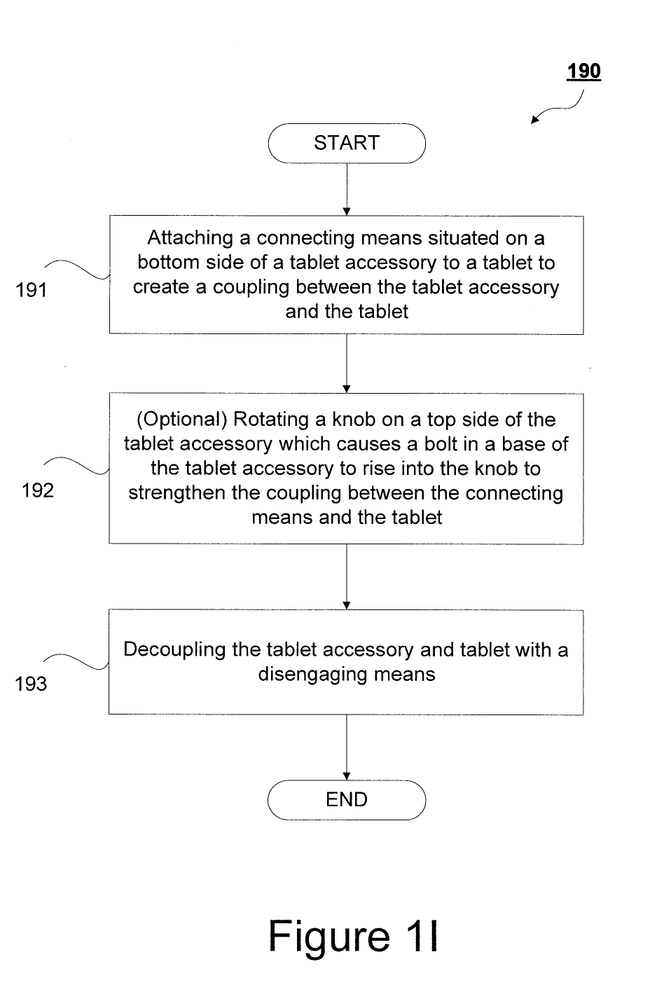

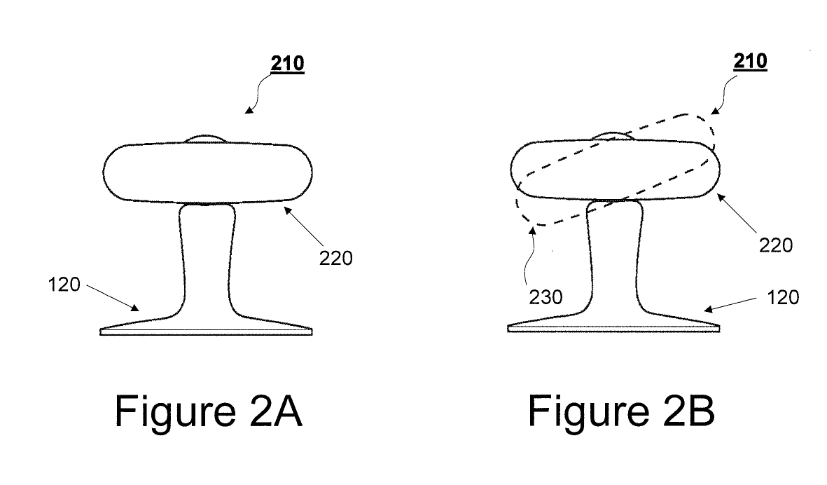

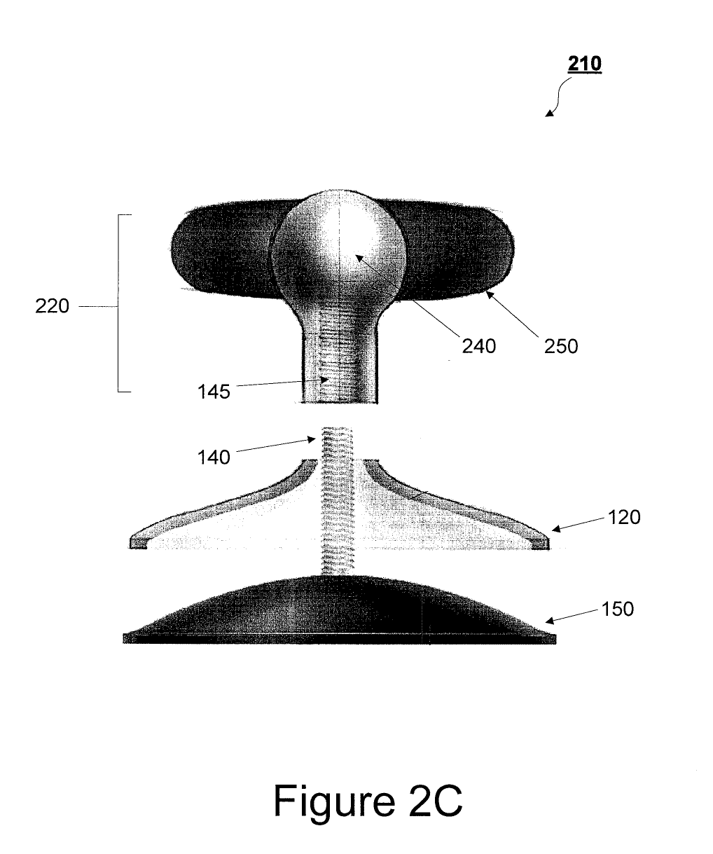

Referring now to FIGS. 2A-2C, an alternate embodiment of a tablet accessory 210 is disclosed. In this embodiment, the tablet accessory 210 includes a pivoting knob 220 which can accommodate different hand positions and hand sizes, and which permits a user's hand 40 to remain in one location while manipulating the tablet 20. The design of this embodiment of the tablet accessory 210 permits it to be held in the same manner described above with respect to FIGS. 1B-1, 1B-2 and 1B-3.

FIG. 2C illustrates a cross-sectional view of a tablet accessory 210 with a pivoting knob 220. As shown therein, the pivoting knob 220 includes a circular ball 240 and tilting handle 250. The tilting handle 250 may be made of rubber and may include a socket for receiving the circular ball 240. This ball and socket connection provided by the coupling of the circular ball 240 and tilting handle 250 permits the tilting handle 250 to rotate, tilt and pivot freely around the circular ball 240, while securing the tilting handle 250 to the circular knob 240. The dotted line 230 in FIG. 2B indicates an exemplary range of motion which may be provided by the pivoting knob 210.

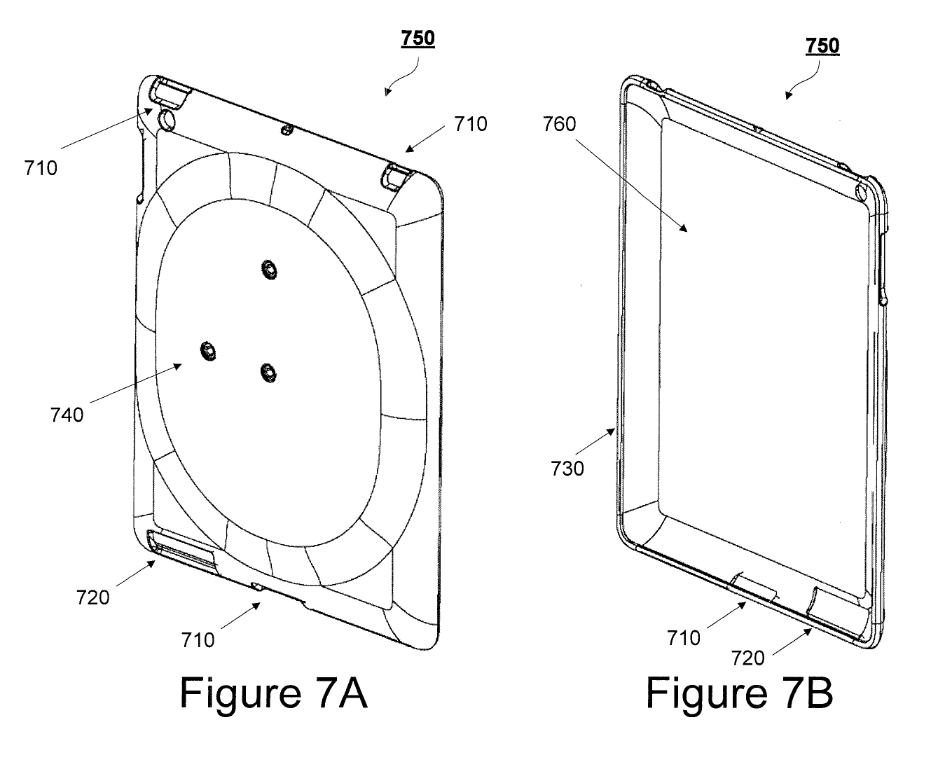

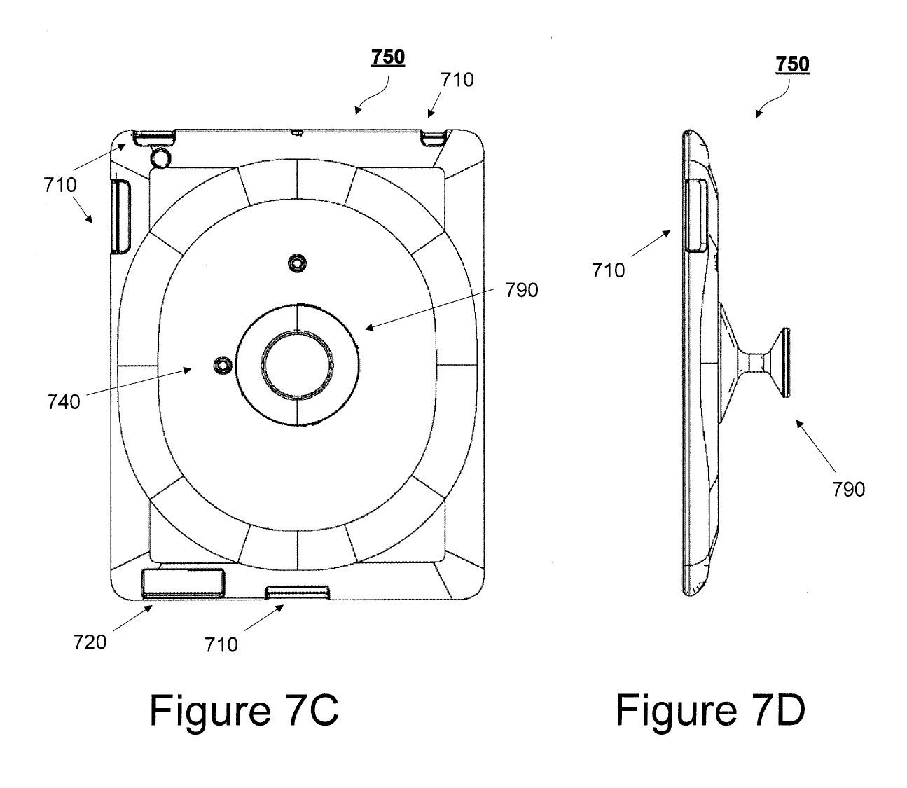

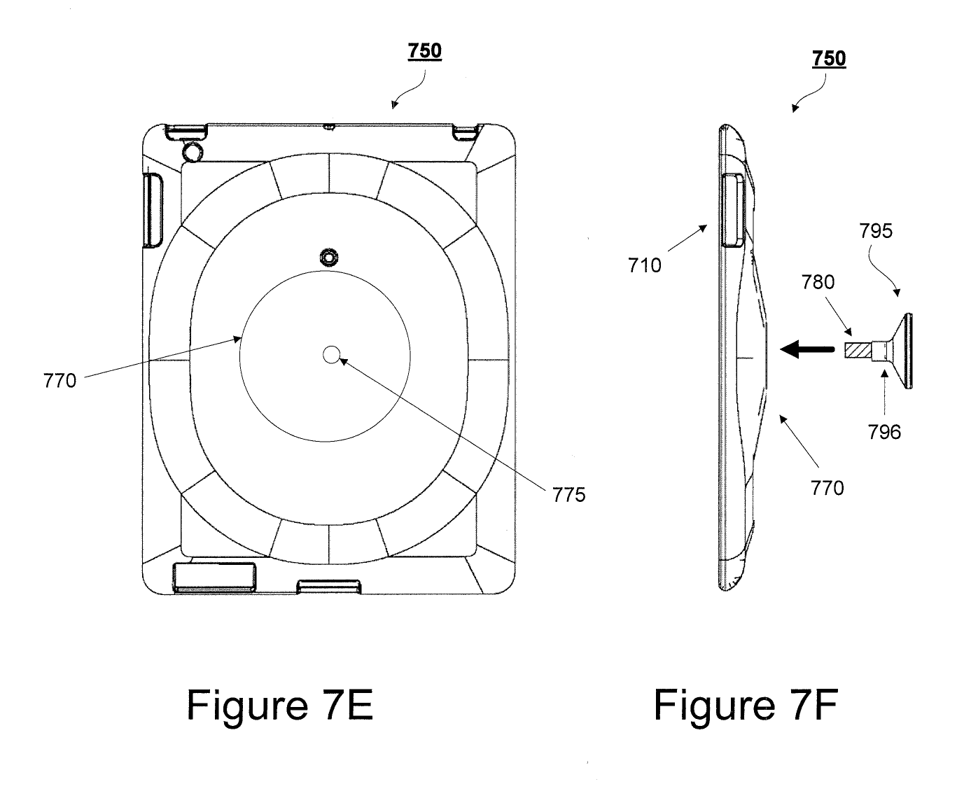

The pivoting knob 220 includes a threaded recess 145 which can receive a threaded bolt 140 that is attached to a suction cup 150 and which extends through a centrally located hole in the base 120. The rotation of the knob 220 may create a vacuum seal between the suction cup 150 and a tablet 20 in the same or similar manner discussed above with reference to FIG. 1C (i.e., by causing the threaded bolt 140 to rise into the threaded recess 145 in the knob 220 and pull on the top of the suction cup 150). However, it should be recognized that this embodiment of the tablet accessory 210 can be outfitted with other types of connecting means including, but not limited to, a connecting portion 70 which is configured to mate with a receiving portion 60 located on the tablet 20 (or a receiving portion 60 located a case which houses a tablet 20 as described below with reference to FIGS. 7A-7F).

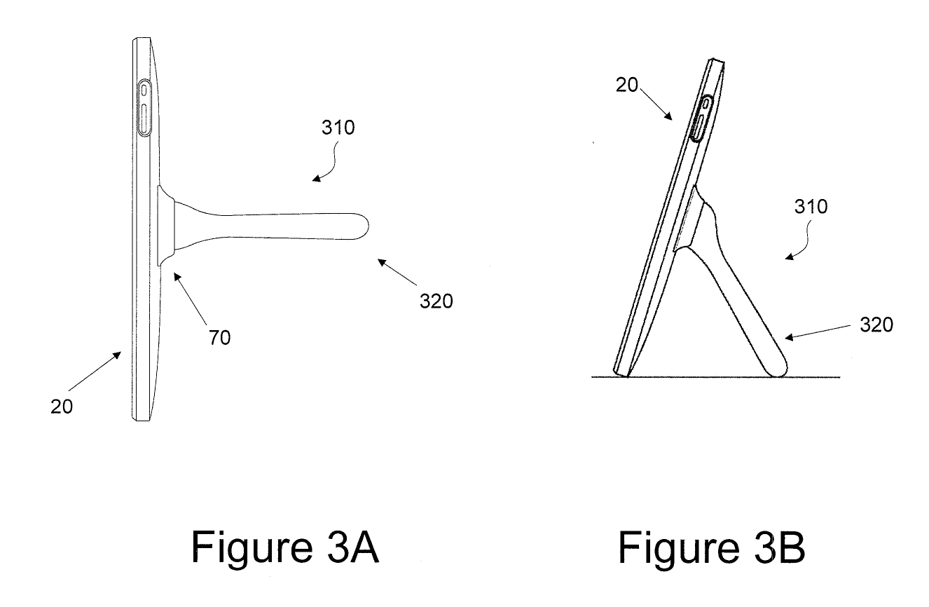

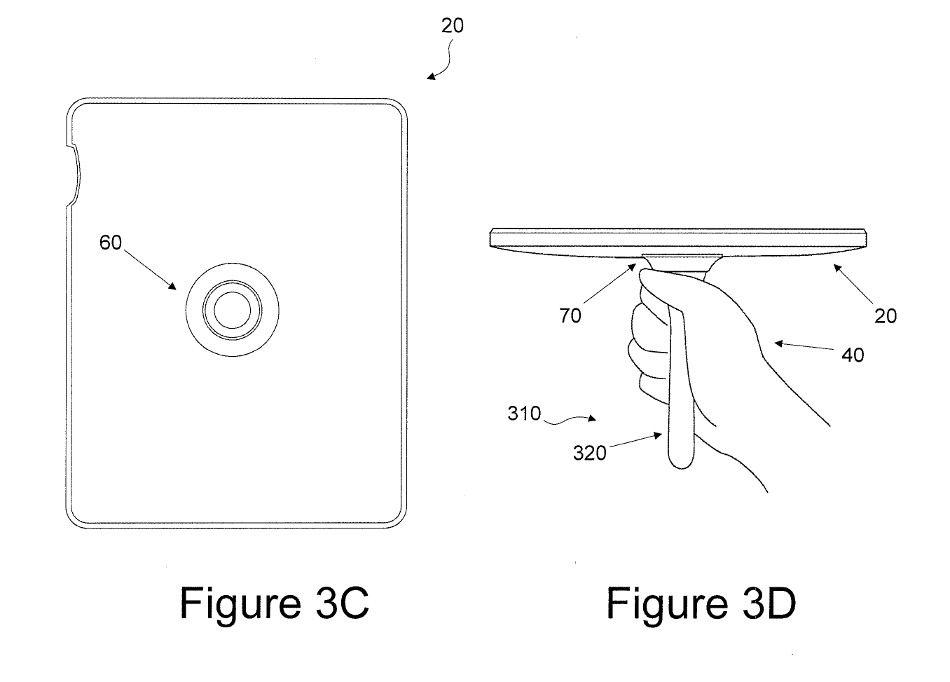

FIGS. 3A-3D disclose another exemplary embodiment of a tablet accessory 310 which comprises a handle stick 320 portion. A side view of the handle stick tablet accessory 310 attached to a tablet 20 is illustrated in FIG. 3A. As can be seen, the handle stick tablet accessory 310 comprises a handle stick 320 and a connection portion 70. The connection portion 70 is configured to be received by a receiving portion 60 located on a tablet 20 (e.g., such as the receiving portion 60 illustrated in FIG. 3C).

The handle stick 320 provides a long shaft that fits easily into a user's hand 40 and which permits the user to comfortably hold the tablet 20 while it is being used. FIG. 3D illustrates how a user 5 can hold or manipulate a tablet 20 with a handle stick tablet accessory 310 using a single hand 40.

FIG. 3B illustrates how the handle stick tablet accessory 310 can be used as a stand to support a tablet 20. Similar to the tablet accessory 310 with the dome portion 320 (discussed above with respect to FIGS. 3A-3D), the handle stick tablet accessory 310 can be used to support the tablet 20 without having to attach any additional components. As illustrated in 3B, the handle stick 320 portion of the tablet accessory 310 can be adjusted at a downward angle to support the tablet 20 in a standing position, while leaving intact the connection between the receiving portion 60 and connecting portion 70. This may be accomplished by providing a hinge, ball and socket connection, or other similar adjustment means, in the location where the handle stick 320 is joined to the connecting portion 70. Depending upon the particular adjustment means which is employed, the tablet accessory 310 may also comprise a locking means for locking the position of the handle stick 320 in a desired location.

The adjustment means included on the handle stick 320 is not only applicable when the tablet accessory 10 is being utilized as a stand, but may also be used when the user 5 is holding the handle stick 320 or otherwise manipulating the tablet 20 with handle stick 320. For example, it may be more comfortable for a user 5 to hold a handle stick 320 at a reclined angle when operating the tablet 20, rather than holding a handle stick 320 which is positioned perpendicular with respect to the tablet 20 (in the manner depicted in FIG. 3D). This can be accomplished by altering the adjustment means.

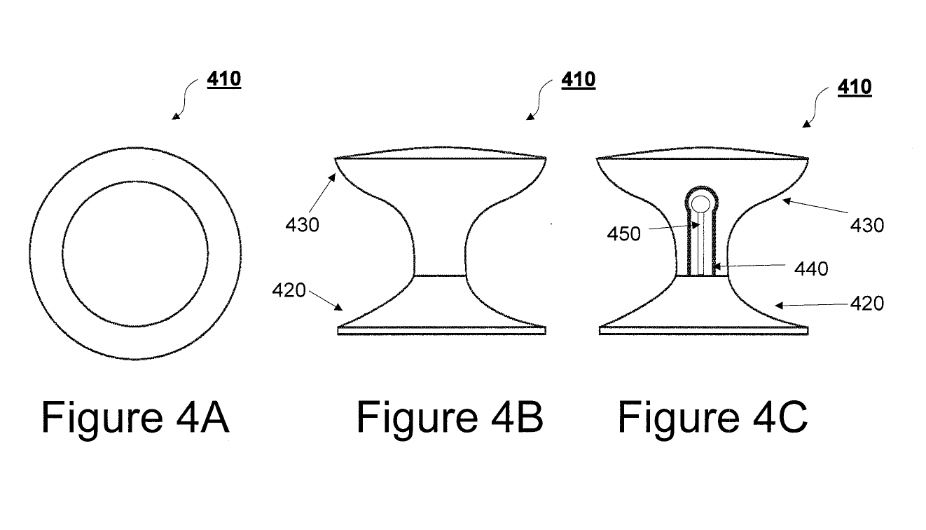

Another exemplary embodiment of a tablet accessory is disclosed in FIGS. 4A-4C which permits a user 5 to spin an attached tablet 20. A top view of this spinning tablet accessory 410 is provided in FIG. 4A, and a side view is provided in FIG. 4B. FIG. 4C further provides a cross-sectional view of the spinning tablet accessory 410.

The spinning tablet accessory 410 includes a knob 430 and a base that rotate freely with respect to each other. For example, when a user 5 is holding the knob 430, the user 5 can rotate or spin a tablet 20 attached to the base 420 continuously in a circular manner. The knob 430 will remain stationary in the user's hand while the attached base 420 spins with the tablet 20. The spinning motion does not cause the decoupling of the base 420 and the knob 430. Rather, the base 420 will remain securely connected to the knob 430.

The base 420 and the knob 430 are able to spin freely with respect to each other because of the “push-in” connection which is employed to connect the base 420 to the knob 430. For example, in one embodiment, the base 420 includes a bolt 450 with a rounded top portion which can be received by a recess 440 in the knob 430. The recess 440 includes a circular portion which is slightly wider than the shaft of the recess 440. When the rounded top portion of the bolt 450 is received in the circular portion of the recess 440, the knob 430 and the base 420 will be securely coupled to each other.

The secure coupling of the knob 430 and the base 420 may be facilitated by retractable notches (not shown) which protrude outwardly from the rounded top portion of the bolt 450 when the knob 430 and base 420 are separated. As the knob 430 and base 420 are being coupled, the bolt 450 is slid into the narrow shaft portion of the recess 440 and the narrow shaft pushes on the notches, thus causing the notches to retract into the rounded portion of the bolt 450. When the rounded portion of the bolt 450 is received by the circular portion of the recess 440, the widened circular portion of the recess 440 permits the notches to return to the original position in which they are protruding from the top portion of the bolt 450. The protruding notches on the bolt 450 provide for a secure coupling of the knob 430 to the base 420, and facilitate a coupling in which the base 420 and the knob 430 are able to spin freely with respect to each other.

It should be recognized that that the “push-in” connection described with respect to FIGS. 4A-4C can be altered in various manners. For example, rather than including the retractable notches on the bolt 450, the notches can be located in the recess 440 at the location where the shaft of the recess 440 meets the circular portion of the recess 440. When the bolt 450 approaches the circular portion of the recess 440, the rounded portion of the bolt 450 pushes on the notches causing them to retract into the knob 430. After the rounded portion of the bolt 450 is received in the circular portion of the recess 440, the notches return to their original position and protrude outwardly to securely couple the knob 430 and the base 420.

In an even further embodiment, the tablet accessory 410 may not include the rounded top portion of the bolt 450 or the circular portion of the recess 440. In this case, the notches may be located on the shaft of the bolt 450 and the recess 440 may include a slightly widened area at some location. When the bolt is slid into the shaft of the recess 440, the notches will retract into the shaft of the bolt 450. When the notches on the bolt 450 reach the widened area in recess 440, the notches will protrude outwardly into the widened area and secure the knob 430 to the base 420. The widened area of the recess may be located around the entire circumference of the recess 440 to permit the knob 420 and the base 420 to rotate freely with respect to each other. It should be recognized that the present principles encompass other variations of the connection illustrated in FIGS. 4A-4C.

The spinning tablet accessory 410 may also include a release mechanism (not shown) which can be used to decouple the knob 430 and the base 420. In some embodiments, the release may be located on the portion of the spinning tablet accessory 410 (i.e., the base 420 or the knob 430) which includes the notches. The release may cause the notches to retract so that the knob 430 and the base 420 can be decoupled. Other types of release mechanisms may also be employed.

It is noted that the design of this tablet accessory 410 permits for the advantageous gripping of a tablet 20 in the same manner discussed above with reference to FIG. 1B-1 (i.e., where a user's fingers are positioned in the spacing between the knob 110 and base 120 so that the shaft 130 is situated between two of the user's fingers 30) and FIG. 1B-2 (i.e., where the user's palm holds the knob 110 and the user's fingers 30 grip the underside of the knob 110).

Once again, the spinning tablet accessory 410 can be coupled to a tablet 20 using any suitable connecting means, including, but not limited to, any connecting means described in this disclosure.

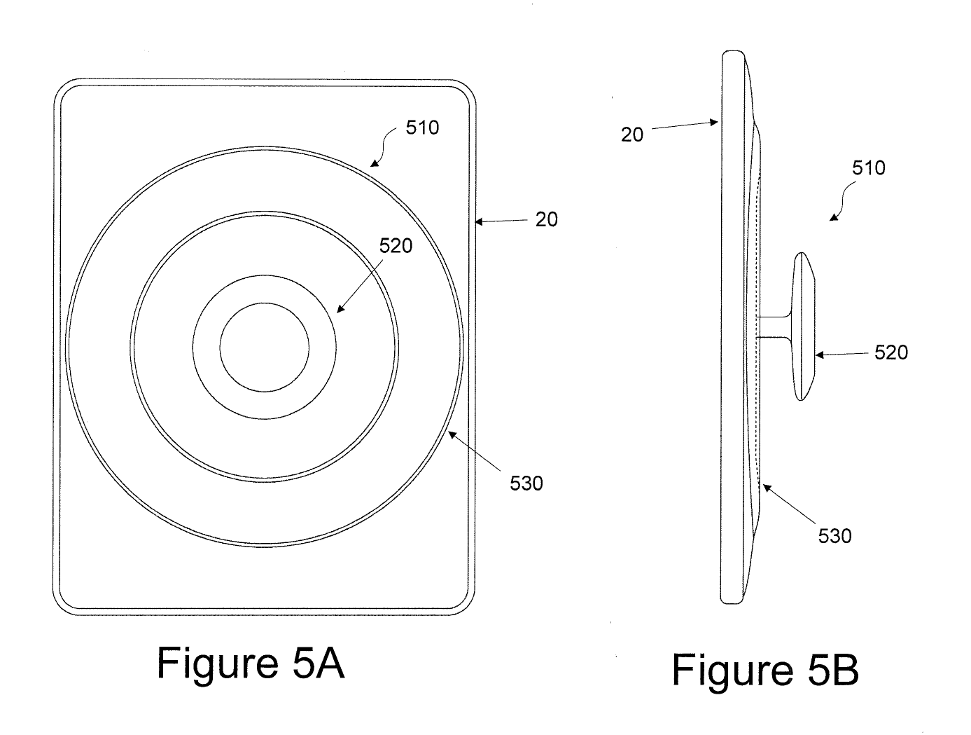

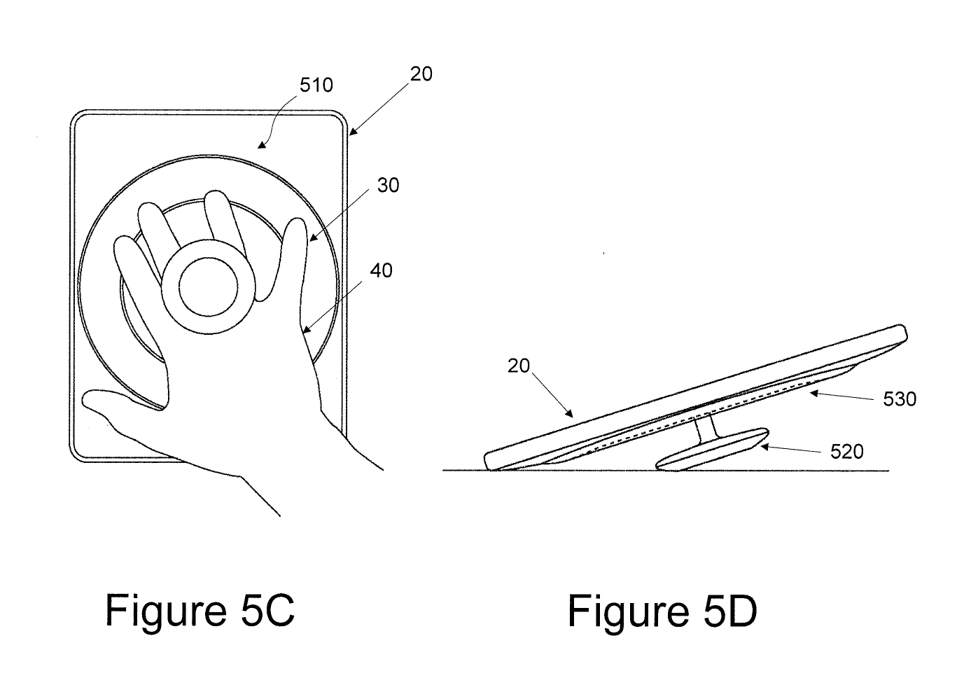

FIGS. 5A-5D illustrate another exemplary embodiment of a tablet accessory 510 which comprises a T-shaped handle 520. FIG. 5A provides a top view of the T-handle tablet accessory 510 attached to a tablet 20, while 5B provides a side view of the same.

As illustrated in the figures, the tablet accessory 510 includes a T-shaped knob 520 and a large, flat base portion 530. The T-shaped knob 520 acts a fixed pivot that can be easily removed or replaced as needed. Thus, a user 5 can leave the base 530 attached to the tablet 20 and unscrew the T-shaped knob 520 when he or she desires. Since the base portion 530 is designed with a relatively flat design, the storage of the tablet accessory 510 is not impeded despite the fact that the base 530 remains attached to the tablet 510. Thus, the tablet 20 can still be stored in relatively confined spaces (e.g., a retaining or protective sleeve for the tablet 20, a school or gym locker, etc.) while the base is attached, and a user 5 can quickly and easily screw on a knob 520 (or otherwise connect the knob 520) to assemble the tablet accessory 510 when the user 5 wishes to use the tablet accessory 510.

FIG. 5C demonstrates that the T-shaped knob 520 permits a user 5 to easily manipulate the tablet 20 by positioning the shaft of the T-shaped handle 520 between his or her fingers 30 (e.g., as illustrated in FIGS. 1B-1 and 1B-3). However, the T-handle tablet accessory 510 can also be comfortably and securely held by holding the T-shaped handle in the palm of the user's hand 40 and gripping the underside of the knob 520 with the user's fingers (e.g., as illustrated in FIG. 1B-2). To facilitate the second type of gripping where a user 5 grips the T-shaped knob 520 with his or her palm, the T-shaped knob 520 may include two advantageous features. First, a soft over-mold may be incorporated into the knob. Second, a raised rib may be included on the underside the knob 520 which can be gripped by a user's fingers 30.

FIG. 5D demonstrates how the T-handle tablet accessory 510 can be used as a stand which supports a tablet 20 in a reclined position without having to attach any additional components. Advantageously, the tablet accessory 510 can be used as stand regardless of whether the tablet 20 is situated in a portrait or landscape position.

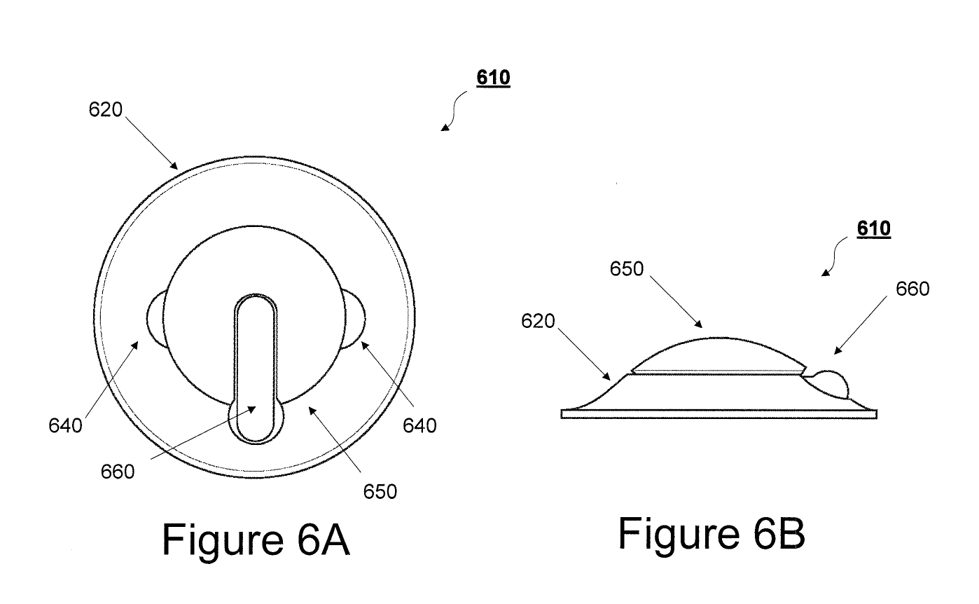

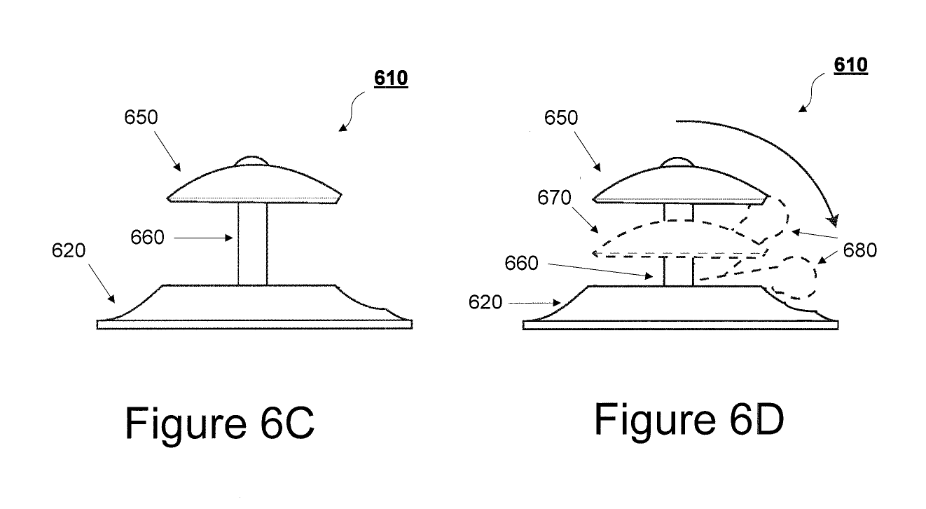

Referring now to FIGS. 6A-6D, an umbrella tablet accessory 610 is disclosed in accordance with an embodiment of the present principles. The umbrella tablet accessory 610 comprises an umbrella knob 650 which can be raised or lowered. FIGS. 6A-6B provide a top view and side view, respectively, of the tablet accessory 610 when the umbrella knob 650 is in a lowered position. FIG. 6C provides a side view of the tablet accessory 610 when the umbrella knob 650 is in a raised position.

Upon initially attaching the umbrella tablet accessory 610 to a tablet 20, the accessory 610 is in a closed position. When the tablet accessory 610 is in a closed position, the umbrella knob 650 is lowered and in contact with the base 620. A suction cup, or other connecting means, located on the underside of the base 620 can couple the tablet accessory 610 to a tablet 20. To strengthen the connection between the tablet accessory 610 and a tablet 20, a user 5 can pull back on the umbrella knob 650 so that the knob 650 is in a raised position (as illustrated in FIG. 6C). Finger receiving channels 640 permit a user 5 to easily grip the underside of the knob 650. When the umbrella knob 650 is in a raised position, a secure connection is provided between the tablet 20 and the tablet accessory 610.

FIG. 6D illustrates two ranges of motion associated with the umbrella tablet accessory 610. Specifically, the dotted line labeled 670 indicates that the umbrella knob 650 can slide vertically from a raised position to a lowered position. The dotted lines labeled 680 indicate that the shaft 660 is anchored near the center of the base 620, and can pivot about its anchored position in a semi-circular motion. Thus, when the umbrella tablet accessory 610 is in a lowered position, the shaft is situated parallel to the base 620. On the other hand, when the tablet accessory 610 is in a raised position, the shaft 620 is situated perpendicular with respect to the base 620.

In an embodiment, the umbrella tablet accessory 610 may be permanently coupled to a tablet 20. For example, an adhesive may be used to permanently secure the tablet accessory 610 to a tablet 20 or a tablet case. As another example, the tablet accessory 610 may be built-in or integrated into a tablet case (note: exemplary tablet cases are described in further detail below). Other means of permanently connecting the tablet accessory 610 may also be employed in accordance with the present principles.

The umbrella-shaped design of the tablet accessory 610 is advantageous in the case where the tablet accessory 610 is permanently affixed. Specifically, the non-protrusive design of the umbrella shaped knob 650 permits a user 5 to easily store the tablet accessory 610. In addition, if a user 5 wishes to hold and operate a tablet 20 without the assistance of the tablet accessory 610, the design of the tablet accessory 610 will not hinder the user 5 from doing so.

The umbrella tablet accessory 610 can be outfitted with any of the connecting means described herein. In addition, the umbrella tablet accessory 610 may include a release (not shown) for breaking the connection between the umbrella tablet accessory 610 and the tablet 20. Thus, when the umbrella knob 650 is in a raised position and the tablet accessory 610 is securely attached to the tablet 20, a user 5 can use the release to disengage the connection and remove the tablet accessory 610. For example, depending upon the particular connection means which is included on the tablet accessory 610, pulling up on the release may cause a decoupling mechanism which breaks a vacuum seal, disengages two magnets, disengages teeth 71 employed in a stick-and-click connection, etc.).

Referring now to FIGS. 7A-F, a tablet accessory including a tablet case 750 is illustratively shown in accordance with an embodiment of the present principles. FIG. 7A illustrates an outside surface of the tablet case 750, while FIG. 7B shows an inside surface of the tablet case 750.

The tablet case 750 can be press-fitted or otherwise attached to a tablet 20. The back of a tablet 20 being attached to the case 750 comes in contact with inside surface 860 of the case 750. When the tablet case 750 is properly attached to the tablet 20, a small edge or lip 730 protrudes over the front perimeter of the tablet 20. The lip 730 can be used to snap the casing 750 onto the tablet 20 and to provide a secure, non-permanent coupling between the tablet 20 and the casing 750.

The case 750 may be designed with a plurality of openings 710 and 720 in predetermined positions depending on the design of the tablet 20. For example, the case 750 may include plug openings 710 which permit plugs or electrical cords to be attached to the tablet 20 when the tablet 20 is in the case 750, or sound openings 720 near the speakers on tablet 20 which permit for the passage of sound. Additional types of openings may be included for other reasons as well.

FIGS. 7C and 7D disclose an exemplary embodiment of a tablet accessory 790 including a tablet case 750. Any of the tablet accessories described in this disclosure can be coupled to the case 750. Other tablet accessories may also be attached. In certain embodiments, the tablet accessory 790 attached to the case 750 may comprise a knob and the base which are detachable from each other. In other embodiments, the knob and base may be fixedly connected to each other such that they are inseparable.

Any suitable means can be utilized to provide such a coupling between the tablet accessory 795 and the tablet case 750 including, but not limited to, any of the connecting means described in this disclosure. In one embodiment, the tablet accessory many include a suction cup 150, adhesive, or other similar connecting means which can be directly coupled to a surface of the tablet case 750. In another embodiment, the tablet casing 750 may also include a case receiving portion 740 which can mate with a corresponding connecting portion 70 on the tablet accessory 10. In an even further embodiment, the tablet case 750 may include an adhesive strip or connecting means which permits the connection of the tablet accessory 795.

FIG. 7A discloses an exemplary tablet case 750 having a receiving portion 740 which comprises three threaded holes that can be coupled to a threaded connecting portion of a tablet accessory 790. Thus, if a particular tablet model is not outfitted with a receiving portion 740 and/or is not suitable for attaching to a suction cup 150 or other connecting means, an individual could simply attach a case 750 that has a receiving portion 740 to the tablet 20 in order to provide a means for connecting a tablet accessory 790.

FIGS. 7E and 7F disclose an embodiment of a tablet accessory including a tablet case 750 with an integrated base 770. In an embodiment, the integrated base 770 bulges or protrudes slightly from the backside of the tablet case 750. The integrated base 770 may be permanently integrated into the case 750 so that it is not removable from the case 750. The center of the base 770 includes a base receiver 775 for connecting a knob 795. The receiver 775 may employ any suitable means for connecting the knob 795 (e.g., threaded bolt connection, plug-in connection, stick-and-click connection, etc.) including, but not limited to, any of the connecting means described in this disclosure. The knob 110 may include a corresponding knob connector 780 for coupling to the receiver 775. In the exemplary embodiment depicted in FIGS. 7E-7F, the base receiver 775 includes a threaded recess and the knob connector 780 comprises a threaded screw.

The embodiment in which the case 750 includes an integrated base is advantageous because a user 5 can easily attach and assemble a tablet accessory. Since the tablet case 750 has an attached base 770, a user 5 only needs to attach a knob 795 to assemble and use the tablet accessory 790. Moreover, because the base 770 is designed to be relatively flat, the tablet accessory 790 can easily be stored in confined storage areas when the case 750 is still attached.

In the embodiment where the case 750 includes an integrated base, it may be preferable to integrate the entirety of the shaft 796 into the knob 795 (e.g., as opposed to providing a shaft 796 which is comprised of portions from both the knob 795 and the base 770). If the shaft 796 is not entirely integrated into the knob 110, the shaft 796 may protrude from case 750 when the knob 795 is detached, thus impeding the storage of the tablet 20 when the case 750 is attached and preventing the case 750 from being laid flat on its outer surface. Hence, integrating the entirety of the shaft 796 into the knob 795 permits the tablet case 750 with an attached base 770 to remain relatively flat and avoid these problems.

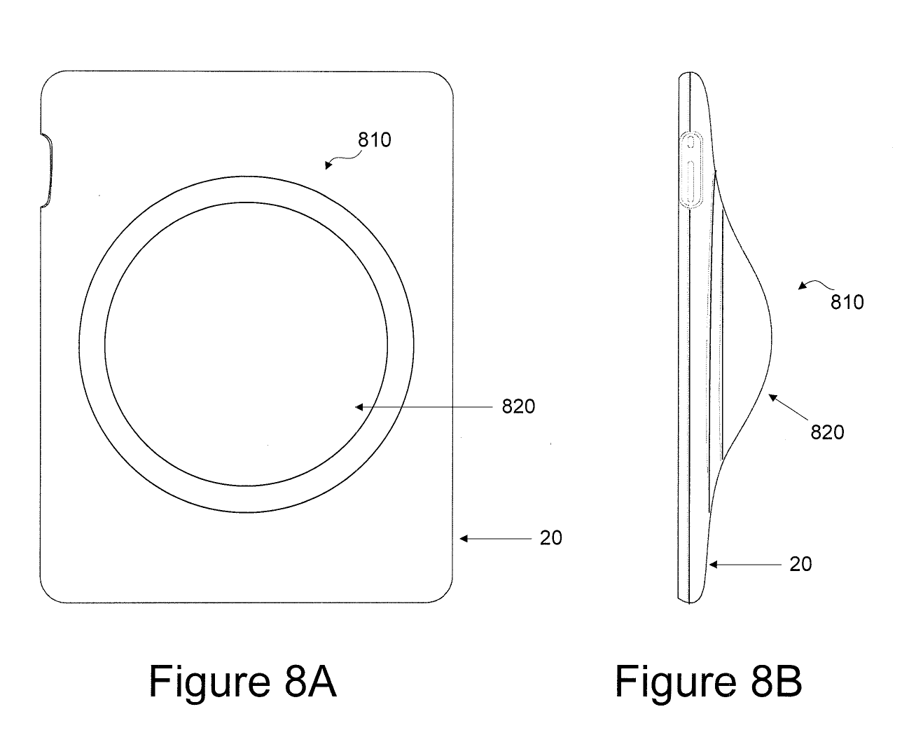

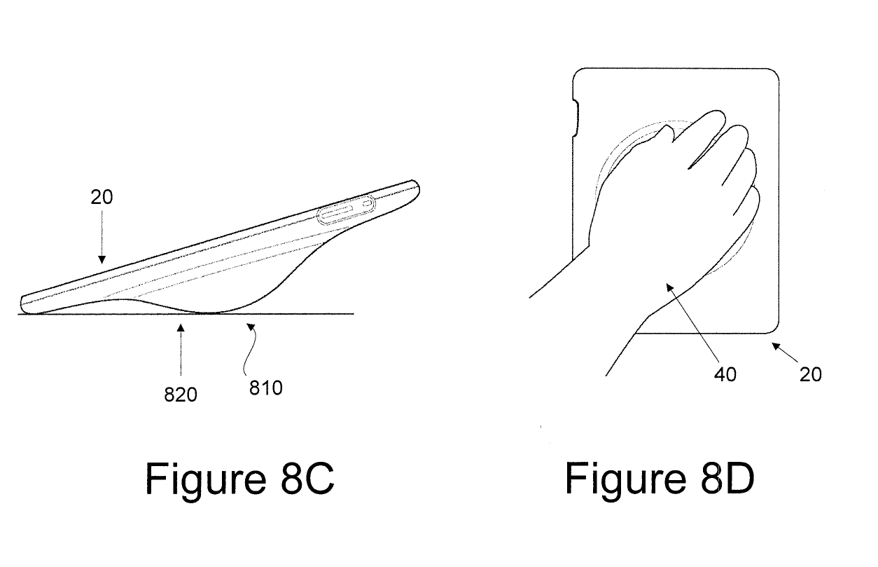

Another embodiment of a tablet accessory 810 is disclosed in FIGS. 8A-8D. FIG. 8A provides a top view of the tablet accessory 810 attached to a tablet 20, while FIG. 8B provides a side view of the same.

This embodiment of the tablet accessory 810 differs from other embodiments which have a clearly defined knob 110 and base 120 portions that come together to form a shaft 130 which the user 5 can position his fingers around to securely manipulate an attached tablet 20. Rather, as illustrated in these figures, this embodiment of the tablet accessory 810 comprises a dome portion 820 which a user 5 can grasp with his or her palm and fingers 30 to hold or manipulate the tablet 20. FIG. 8D illustrates how a user can hold the dome portion 820 to securely manipulate the tablet 20 with a one hand.

Although it is not necessary, the dome portion 820 may include a gripping means (not shown) to assist a user in gripping the tablet accessory 810. For example, the dome portion 820 may incorporate rubber, or other grip-promoting material, where the user 5 will place his or her hand 40. Alternatively, the dome portion 820 may include a depressed surface portion, possibly in the shape of hand, where the user's hand 40 is placed. Many other types of gripping means are contemplated and intended be encompassed by the present principles.

The dome-shaped tablet accessory 810 can be attached to a tablet 20 or tablet case 850 using a connecting portion 70 located on the accessory 810 which engages a corresponding receiving portion 60 located on the tablet 20 (e.g., as described above with respect to FIGS. 1G and 1H) or case containing the tablet. Alternatively, the tablet accessory 810 can be outfitted with a suction cup 150, adhesive or other connecting means which does not mate with a corresponding receiving portion 60 on the tablet 20. In the case where a suction cup 150 is included, the dome portion 820 can be configured to be rotatable. The rotation of the dome portion 820 can be used to strengthen a vacuum sealed connection between the base of the tablet accessory 810 and the tablet 20 in the same manner described above with respect to FIGS. 1C-1D.

FIG. 8C illustrates that the dome portion 820 can be also be used as a stand to support a tablet 20 without having to attach any additional parts. As shown therein, once the tablet accessory 810 has been attached, the tablet 20 can be turned on its back. The design of this particular tablet accessory 810 will support the tablet 20 in a reclined position.

Having described preferred embodiments of a system and method for a tablet accessory (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A tablet accessory, comprising:
a base having two opposing ends;
a knob attached to a first end of the base; and
connecting means integrated into a second end of the base, said connecting means configured to connect the base to an exterior surface of a tablet.

2. The tablet accessory as recited in claim 1, wherein the knob comprises a threaded recess, the connecting means comprises a suction cup and a bolt with an upper threaded portion, and rotating the knob causes the bolt to rise into the threaded recess and to pull on the suction cup to create a vacuum seal between the base and the tablet.

3. The tablet accessory as recited in claim 2, further comprising an inside wall integrated into the base, the inside wall in contact with the suction cup to keep the suction cup attached to the exterior surface of the tablet when the bolt is pulling on the suction cup.

4. The tablet accessory as recited in claim 1, wherein the connecting means comprises a connector that is configured to be received by a receiving portion located on the tablet.

5. The tablet accessory as recited in claim 4, wherein the connector comprises one selected from a group consisting of a magnetic connector, a stick-and-click connector, a push-in connector, an adhesive connector or a threaded connector.

6. The tablet accessory as recited in claim 1, further comprising a central shaft which is formed between the second end of the base and an outer surface of the knob located distally with respect to the base, wherein the central shaft can be positioned between a user's fingers to permit the user to securely manipulate a tablet coupled to the connecting means.

7. The tablet accessory as recited in claim 6, wherein the central shaft has a width which is smaller than both the second end of the base and an outer surface of the knob located distally with respect to the base.

8. The tablet accessory as recited in claim 1, further comprising a stand which can be attached to the tablet accessory to support the tablet.

9. The tablet accessory as recited in claim 8, wherein the stand comprises an adjusting means which permits a user to precisely set a position of the tablet.

10. The tablet accessory as recited in claim 1, wherein an underside of the knob located proximal with respect to the base is sloped at an upward angle and the first side of the base is sloped at a downward angle to provide a spacing for receiving a user's fingers.

11. The tablet accessory as recited in claim 1, wherein said exterior surface of the tablet comprises a surface located on a detachable case which contains the tablet.

12. The tablet accessory as recited in claim 1, further comprising an insert which is attached to or integrated into the knob for attaching at least one of a logo, a label or an advertisement.

13. A tablet accessory, comprising:
a base having two opposing ends;
a knob located adjacent to a first end of the base; and
connecting means integrated into a second end of the base, said connecting means configured to connect the base to a tablet case.

14. The tablet accessory as recited in claim 13, wherein the base and knob are integrated together and are permanently attached to each other.

15. The tablet accessory as recited in claim 13, wherein the connection means comprises one selected from a group consisting of a magnetic connector, a stick-and-click connector, an adhesive connector, a push-in connector or a threaded connector.

16. A tablet accessory, comprising:
a case having an inner surface and an outer surface, wherein:
said inner surface is configured to receive a back of a tablet;
said outer surface having at least one receiver; and
a knob comprising a shaft with an integrated connector for coupling the knob to the receiver.

17. The tablet accessory as recited in claim 16, wherein the case comprises an integrated base, and said receiver is located on the integrated base for coupling the knob to the base.

18. The tablet accessory as recited in claim 16, wherein the shaft has a width which is smaller than an outer edge of the knob located distally with respect to the shaft.

19. The tablet accessory as recited in claim 17, wherein an underside of the knob located proximal with respect to the shaft is sloped at an upward angle and a top portion of the integrated base located proximal to the shaft is sloped at a downward angle to provide a spacing for receiving a user's fingers when the knob is coupled to the base.

20. The tablet accessory as recited in claim 16, wherein the connector comprises one selected from a group consisting of a magnetic connector, a stick-and-click connector, an adhesive connector, a push-in connector or a threaded connector.
